(19) United States
(12) Patent Application Publication
(10) Pub. No.: US 2026/0222360 A1
(43) Pub. Date: Jul. 30, 2026

(54) ELECTRONIC DEVICE AND OPERATING METHOD THEREOF

(71) Applicant: SAMSUNG ELECTRONICS CO., LTD., Suwon-si (KR)

(72) Inventor: Ho Young Kim, Suwon-si (KR)

(73) Assignee: SAMSUNG ELECTRONICS CO., LTD., Suwon-si (KR)

(21) Appl. No.: 19/266,803

(22) Filed: Jul. 11, 2025

(30) Foreign Application Priority Data
Jan. 24, 2025 (KR) 10-2025-0011970

(51) Int. Cl. H04L 47/70; G06F 9/50; H04L 7/00

(52) U.S. Cl. CPC H04L 47/70; G06F 9/5061; H04L 7/0008

(57) ABSTRACT

An electronic device, including: a first node configured to perform a first computation, and to transmit first data stored in an first memory region allocated to the first node at a first bandwidth while performing the first computation; and a second node configured to receive the first data from the first node, receive second data from a second memory region allocated to the second node at an input rate, and perform a second computation based on the received second data while receiving the first data, wherein the first bandwidth corresponds to the input rate.

### CROSS-REFERENCE TO RELATED APPLICATION

This application is based on and claims priority under 35 U.S.C. § 119 to Korean Patent Application No. 10-2025-0011970, filed on Jan. 24, 2025, in the Korean Intellectual Property Office, the disclosure of which is incorporated by reference herein in its entirety.

### BACKGROUND

### 1. Field

The present disclosure relates to an electronic device and an operating method thereof.

### 2. Description of the Related Art

As large networks such as large language model (LLMs) become more widely used, distributed processing using multiple computing nodes has become important. This may cause large amounts of data to be moved between computing nodes. Double buffering may be used to move and use data. Double buffering may refer to the partitioning of a space at which a node stores data received from another node, a space used for computations, and a space for storing data before transmitting the data. Such double buffering may require a significant amount of data space. Accordingly, a a high bandwidth memory (HBM) may be used to store data, as well as a static random access memory (SRAM).

### SUMMARY

One or more example embodiments may address at least the above problems and/or disadvantages and other disadvantages not described above. Also, the example embodiments are not required to overcome the disadvantages described above, and an example embodiment may not overcome any of the problems described above.

In accordance with an aspect of the disclosure, an electronic device includes: a first node configured to perform a first computation, and to transmit first data stored in an first memory region allocated to the first node at a first bandwidth while performing the first computation; and a second node configured to receive the first data from the first node, receive second data from a second memory region allocated to the second node at an input rate, and perform a second computation based on the received second data while receiving the first data, wherein the first bandwidth corresponds to the input rate.

The first memory region may include a space used for the first computation and a space used for transmission of the first data, and the second memory region may include a space used for reception of the first data, a space configured to store the second data, and a space used for the second computation.

The first node may be configured to receive third data from a first other node while performing the first computation and transmitting the first data, and to store the received third data in the first memory region, and second node may be configured to transmit fourth data stored in the second memory region to a second other node while performing the second computation and receiving the first data.

The first node and the second node may be configured to operate according to a first mode in which the second node may be configured to transmit readiness information indicating that the second node is ready for reception to the first node, and the first node may be configured to transmit the first data to the second node based on the readiness information being received from the second node.

The first node and the second node may be configured to operate according to a second mode in which communication is performed by synchronizing a time of the first node with a time of the second node, wherein according to the second mode, at least one of the first node and the second node may be configured to transmit a synchronization signal in order to synchronize the time of the first node with the time of the second node.

Based on a time difference between a time of the first node and a time of the second node being less than or equal to a threshold value, the first node and the second node may be configured to operate according to a second mode in which communication is performed by synchronizing the time of the first node with the time of the second node, and wherein based on the time difference being greater than the threshold value, the first node and the second node may be configured to operate according to a first mode in which transmission is performed based on a readiness state.

The first bandwidth may be determined by applying a bandwidth scaling value to a maximum bandwidth, and the bandwidth scaling value may correspond to a ratio of the first bandwidth to the maximum bandwidth.

The electronic device may further include: a switch configured to receive the first data from the first node using at least one first channel from among a plurality of first channels connected to the first node, and to transmit the first data to the second node using at least second channel from among a plurality of second channels connected to the second node.

A number of the at least one first channel may be determined based on a bandwidth scaling value.

The first node and the second node may be further configured to operate based on at least one of pipeline parallelism and tensor parallelism.

The electronic device may include a network-on-chip (NoC) structure, and each node from among the first node and the second node may correspond to one or more processing cores included in the NoC structure.

The electronic device may include a multi-chip structure, and each node from among the first node and the second node may correspond to a chip included in the multi-chip structure.

Job partitioning for a plurality of nodes in the electronic device may be performed based on at least one of an output rate of each of the plurality of nodes, a bandwidth of each of the plurality of nodes, and an input rate of each of the plurality of nodes, and a first layer may be allocated to the first node and a second layer may be allocated to the second node as the job partitioning is performed.

The first bandwidth, the output rate of the first node, and the input rate of the second node may be determined to match each other.

In accordance with an aspect of the disclosure a method of operating an electronic device includes: performing, by a first node included in the electronic device, a first computation; transmitting, by the first node, first data stored in a first memory region allocated to the first node at a first bandwidth to a second node included in the electronic device while the first computation is performed; receiving, by the second node, second data from a second memory region allocated to the second node at an input rate; and performing, by the second node, a second computation based on the received second data while the first data is received from the first node, wherein the first bandwidth corresponds to the input rate.

The first memory region may include a space used for the first computation and a space used for the transmitting of the first data, and wherein the second memory region may include a space used for the receiving of the first data, a space configured to store the second data, and a space used for the second computation.

The method may further include: receiving, by the first node, third data from a first other node while the first computation is performed and the first data is transmitted; storing the received third data in the first memory region; and transmitting, by the second node, fourth data stored in the second memory region to a second other node while the second computation is performed and the first data is received.

The first node and the second node may be configured to operate according to a first mode in which transmission is performed based on a readiness state, and the method further may include: transmitting, by the second node operating according to the first mode, readiness information indicating that the second node is ready for reception to the first node; and transmitting, by the first node, the first data to the second node based on the readiness information being received from the second node.

The first node and the second node may be configured to operate according to a second mode in which communication is performed by synchronizing a time of the first node with a time of the second node, and the method further may include: transmitting, by the first node operating according to the second mode, a first synchronization signal to the second node in order to synchronize the time of the first node with the time of the second node; and transmitting, by the second node, a second synchronization signal to the first node in order to synchronize the time of the first node with the time of the second node.

The first bandwidth may be determined by applying a bandwidth scaling value to a maximum bandwidth, and the bandwidth scaling value may correspond to a ratio of the first bandwidth to the maximum bandwidth.

Additional aspects of example embodiments will be set forth in part in the description which follows and, in part, will be apparent from the description, or may be learned by practice of the disclosure.

### BRIEF DESCRIPTION OF THE DRAWINGS

The above and other aspects, features, and advantages of certain embodiments of the present disclosure will be more apparent from the following description with reference to the accompanying drawings, in which:

FIG. 1A is a diagram illustrating an electronic device;

FIG. 1B is a diagram illustrating an electronic device according to an embodiment;

FIG. 2 is a diagram illustrating an example of operations of an electronic device according to a first mode according to an embodiment;

FIG. 3 is a diagram illustrating an example of operations of an electronic device according to a second mode according to an embodiment;

FIG. 4 is a diagram illustrating an example of a state of a memory region allocated to each of a first node and a second node of an electronic device according to an embodiment;

FIGS. 5A to 5D are diagrams illustrating an example of an operation of an electronic device in first model parallelism according to an embodiment;

FIGS. 6A to 6D are diagrams illustrating an example of an operation of an electronic device in second model parallelism according to an embodiment;

FIGS. 7 to 9 are diagrams illustrating a switch of an electronic device according to an embodiment;

FIG. 10 is a diagram illustrating an example of an operation of an electronic device according to an embodiment;

FIG. 11 is a diagram illustrating an example of an operation of an electronic device according to an embodiment;

FIG. 12 is a block diagram illustrating an example of a configuration of an electronic device according to an embodiment; and

FIG. 13 is a flowchart illustrating an operating method of an electronic device according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, or similarly, the second component may be referred to as the first component.

It should be noted that if it is described that one component is “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used herein, “at least one of A and B,” “at least one of A, B, or C,” and the like, each of which may include any one of the items listed together in the corresponding one of the phrases, or all possible combinations thereof. As used herein, expressions such as “at least one of,” when preceding a list of elements, modify the entire list of elements and do not modify the individual elements of the list. For example, the expression, “at least one of A, B, and C,” should be understood as including only A, only B, only C, both A and B, both A and C, both B and C, or all of A, B, and C.

As is traditional in the field, the embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments are described in detail with reference to the accompanying drawings. When describing the embodiments with reference to the accompanying drawings, like reference numerals refer to like elements and a repeated description related thereto may be omitted.

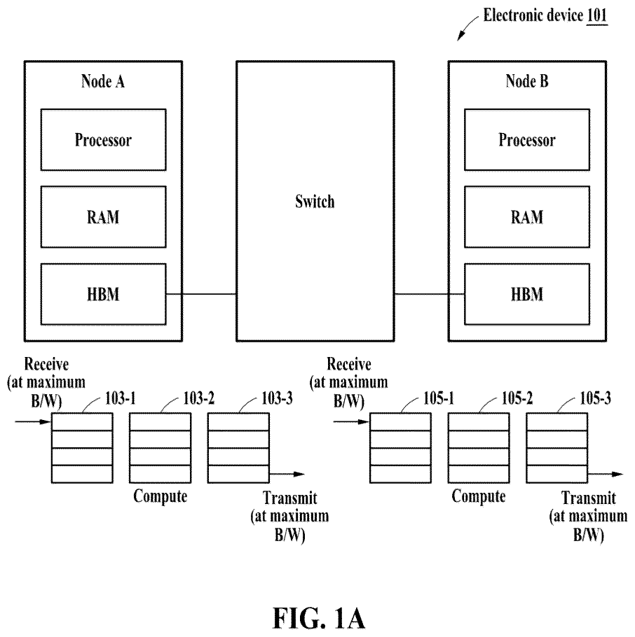

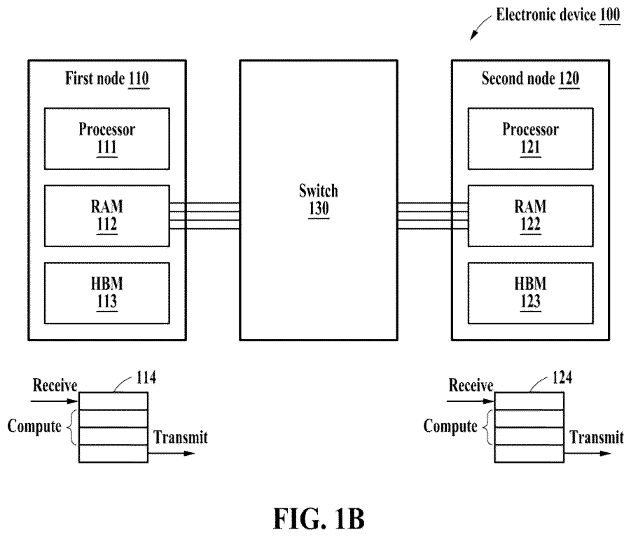

FIG. 1A is a diagram illustrating an electronic device.

Referring to FIG. 1A, an electronic device 101 according to a comparative example may include a node A, a node B, and a switch. The node A and the node B may each include a processor, a random access memory (RAM), and a high bandwidth memory (HBM). The node A and the node B may each perform computations. The switch may transmit data from the node A to the node B, and may transmit data from the node B to the node A.

In the case of the electronic device 101, a memory region for receiving data, a memory region for computations, and a memory region for transmitting data may be separated from each other. For example, each of a memory region 103-1 for receiving data, a memory region 103-2 for computations, and a memory region 103-3 for transmitting data may be allocated to the node A. The memory region 103-1, the memory region 103-2, and the memory region 103-3 may be separated from each other. Each of a memory region 105-1 for receiving data, a memory region 105-2 for computations, and a memory region 105-3 for transmitting data may be allocated to the node B. The memory region 105-1, the memory region 105-2, and the memory region 105-3 may be separated from each other.

The node A may receive data from another node at a maximum bandwidth, and store the received data in the memory region 103-1. The node A may perform computations after data reception is complete. The node A may store intermediate results generated while performing the computations in the memory region 103-2. The node A may store data to be transmitted to the node B in the memory region 103-3. The node A may store all data to be transmitted to the node B in the memory region 103-3, and then transmit the data stored in the memory region 103-3 to the node B using the switch at the maximum bandwidth.

The node B may receive data from the node A at the maximum bandwidth, and store the received data in the memory region 105-1. The node B may perform computations after data reception is complete. The node B may store intermediate results generated while performing the computations in the memory region 105-2. The node B may store data to be transmitted to another node in the memory region 105-3. The node B may store all data to be transmitted to the other node in the memory region 105-3, and then transmit the data stored in the memory region 105-3 to the other node using the switch at the maximum bandwidth.

In the case of the electronic device 101, the memory region for receiving data, the memory region for computations, and the memory region for transmitting data may be separated from each other, and thus, a large memory capacity and a large data space may be used by the electronic device 101. In addition, the node of the electronic device 101 may transmit data at the maximum bandwidth and receive data at the maximum bandwidth, and therefore, the bandwidth may not be partitioned.

FIG. 1B is a diagram illustrating an electronic device according to an embodiment.

Referring to FIG. 1B, an electronic device 100 according to an embodiment may include a first node 110, a second node 120, and a switch 130.

The electronic device 100 may include various electronic devices such as, for example, a high performance computer (HPC), a supercomputer, or a server computer. However, the electronic device 100 is not limited thereto and may include a mobile terminal (e.g., a smartphone, a tablet personal computer (PC), or the like).

Each of the first node 110 and the second node 120 may perform computations. The first node 110 may be represented or referred to as a first computing node, and the second node 120 may be represented or referred to as a second computing node.

The first node 110 may include a processor 111, a RAM 112 (which may be referred to as a first memory) (e.g., a static RAM (SRAM)), and an HBM 113 (which may be referred to as a second memory). The second node 120 may include a processor 121, a RAM 122 (which may be referred to as a first memory) (e.g., a SRAM), and an HBM (123 (which may be referred to as a second memory). The switch 130 may be connected to the first node 110 by one or more channels and may be connected to the second node 120 by one or more channels.

A first memory region 114 may be allocated to the first node 110, and a second memory region 124 may be allocated to the second node 120. The first memory region 114 may be included in, for example, the RAM 112, and the second memory region 124 may be included in the RAM 122.

Unlike the example illustrated in FIG. 1A, as shown in the example illustrated in FIG. 1B, the memory region for receiving data, the memory region for computations, and the memory region for transmitting data may not be separated from each other. In the example illustrated in FIG. 1B, the memory region for receiving data, the memory region for computations, and the memory region for transmitting data may not be allocated separately. Two or more of the reception of data (e.g., the receiving of data), the computations, or the transmission of data (e.g., the transmitting of data) may occur in one allocated memory region.

For example, the reception of data by the first node 110, the computations of the first node 110, and/or the transmission of data by the first node 110 may occur in the first memory region 114 allocated to the first node 110. The first node 110 may perform computations while receiving data. The first node 110 may transmit data while receiving data and performing computations. The reception of data by the second node 120, the computations of the second node 120, and/or the transmission of data by the second node 120 may occur in the second memory region 124 allocated to the second node 120. The second node 120 may perform computations while receiving data. The second node 120 may transmit data while receiving data and performing computations.

According to an embodiment, the reception of data, the computations, and the transmission of data may occur in one allocated memory region. Accordingly, the memory usage of the electronic device 100 may be reduced, the memory usage efficiency may be improved, and relatively less data space may be used by the electronic device 100. In addition, as described below, each node of the electronic device 100 may partition and use the bandwidth.

According to an embodiment, a host processor may perform compilation for an application (e.g., a large language model (LLM)).

The application (e.g., an LLM) may generate a large amount of communication and computation in the electronic device 100. In compilation, the host processor may determine the amount of computation and communication associated with each of the nodes within the electronic device 100.

The host processor may determine an input rate and an output rate of each of the nodes within the electronic device 100 based on the amount of computation and communication of each of the nodes within the electronic device 100. An input rate may, for example, represent or refer to a rate at which a node receives data from an input buffer. The input rate may, for example, represent or refer to a rate indicating how fast a node may receive data from an input buffer. An output rate may, for example, represent or refer to a rate at which a node stores data from an output buffer. The output rate may, for example, represent or refer to a rate indicating how fast a node may store data into an output buffer.

The host processor may determine a bandwidth of each of the nodes within the electronic device 100 (e.g., an interconnection bandwidth between connected nodes, etc.) based on the amount of computation and communication associated with each of the nodes within the electronic device 100. For example, the host processor may determine a bandwidth scaling value based on the amount of computation and communication associated with each of the nodes within the electronic device 100. A bandwidth scaling value may represent or refer to, for example, a ratio indicating the usage of a maximum bandwidth of a node. The bandwidth scaling value of one (“1”) may indicate that the maximum bandwidth of the node is fully used. The bandwidth scaling value of one half (“½”) may indicate that half of the maximum bandwidth of the node is used. The bandwidth scaling value of one quarter (“¼”) may indicate that one quarter (“¼”) of the maximum bandwidth of the node is used. The host processor may determine the bandwidth of each of the nodes within the electronic device 100 by determining the bandwidth scaling value. As described below, the first node 110 may transmit data in the determined bandwidth.

The host processor may allocate a memory region to each of the nodes within the electronic device 100. For example, the host processor may allocate the first memory region 114 to the first node 110 and allocate the second memory region 124 to the second node 120 by performing resource scheduling.

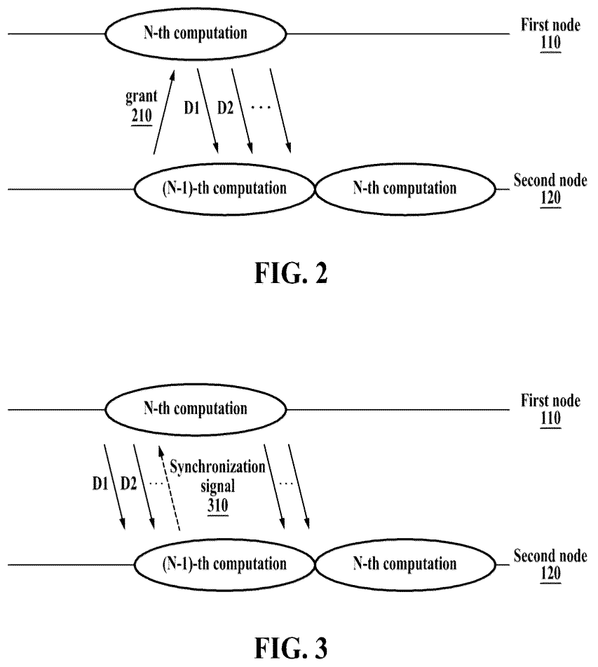

FIG. 2 is a diagram illustrating an example of operations of an electronic device according to a first mode according to an embodiment.

In the example illustrated in FIG. 2, the first mode may represent or refer to, for example, a mode in which transmission of data is performed based on a readiness state, which may represent or refer to a state of being ready for reception.

Referring to FIG. 2, the first node 110 may perform an N-th computation.

The second node 120 may perform a (N-1)-th computation. The second node 120 may transmit readiness information (e.g., grant 210 of FIG. 2) indicating that the second node 120 is in a state of being ready to receive data to the first node 110 while performing the (N-1)-th computation.

Based on the readiness information (e.g., the grant 210) indicating the state of being ready to receive data being received from the second node 120, the first node 110 may transmit data D1 to the second node 120. The data D1 may represent or refer to data used by the second node 120 to perform the N-th computation. The readiness information (e.g., the grant 210) indicating the state of being ready to receive data may include, for example, an input rate of the second node 120 (e.g., a rate at which the second node 120 receives data from the input buffer of the second node 120), but embodiments are not limited thereto. According to an embodiment, the first node 110 may identify the input rate of the second node 120 in advance using the host processor. The first node 110 may transmit the data D1 while performing the N-th computation.

The first node 110 may transmit the data D1 to the second node 120 at a bandwidth (e.g., a bandwidth determined by the host processor or a bandwidth dynamically adjusted using the input rate of the second node 120).

The second node 120 may receive the data D1 from the first node 110. The second node 120 may receive the data D1 from the first node 110 while performing the (N-1)-th computation.

After transmitting the data D1, the first node 110 may transmit data D2 to the second node 120 while performing the N-th computation. The second node 120 may receive the data D2 from the first node 110 while performing the (N-1)-th computation.

After transmitting the data D2, the first node 110 may transmit data (e.g., data to be used for an N-th computation of the second node 120) to the second node 120 while performing the N-th computation. The second node 120 may receive the data to be used for the N-th computation of the second node 120 from the first node 110 while performing the (N-1)-th computation.

The second node 120 may perform the N-th computation after the (N-1)-th computation is completed.

FIG. 3 is a diagram illustrating an example of operations of an electronic device according to a second mode according to an embodiment.

In the example illustrated in FIG. 3, the second mode may represent or refer to, for example, a mode in which nodes perform communication by synchronizing time.

Referring to FIG. 3, the first node 110 may perform the N-th computation, and the second node 120 may perform the (N-1)-th computation.

The first node 110 may transmit the data D1 to the second node 120 at a bandwidth (e.g., a bandwidth determined by the host processor or a bandwidth dynamically adjusted using the input rate of the second node 120) while performing the N-th computation.

The second node 120 may receive the data D1 from the first node 110. The second node 120 may receive the data D1 from the first node 110 while performing the (N-1)-th computation.

After transmitting the data D1, the first node 110 may transmit data D2 to the second node 120 while performing the N-th computation. The second node 120 may receive the data D2 from the first node 110 while performing the (N-1)-th computation.

The second node 120 may transmit a synchronization signal 310 to the first node 110 to synchronize a time of the first node 110 with a time of the second node 120. In some embodiments of the first node 110 and the second node 120 may perform time synchronization, but embodiments are not limited thereto.

The time synchronization between the first node 110 and the second node 120 may be performed periodically.

After the time synchronization, the first node 110 may transmit data to the second node 120. The second node 120 may receive the data to be used for the N-th computation of the second node 120 from the first node 110 while performing the (N-1)-th computation.

The second node 120 may perform the N-th computation after the (N-1)-th computation is completed.

FIG. 3 illustrates an example in which the second node 120 transmits the synchronization signal 310 to the first node 110 for the time synchronization has been described, but this is merely an example, and embodiments are not limited thereto. The first node 110 may transmit a first synchronization signal to the second node 120 to synchronize the time of the first node 110 with the time of the second node 120, and the second node 120 may transmit a second synchronization signal 310 to the first node 110 to synchronize the time of the first node 110 with the time of the second node 120. In some embodiments, the first node 110 may transmit the synchronization signal 310 to the second node 120 for the time synchronization, and the second node 120 may not transmit the synchronization signal 310 to the first node 110.

According to an embodiment, the first node 110 and the second node 120 may operate according to the second mode based on a time difference between the time of the first node 110 and the time of the second node 120 being less than or equal to a threshold value. The time difference between the time of the first node 110 and the time of the second node 120 may exceed the threshold value due to a specific event (e.g., a case in which the electronic device 100 is turned off and then on). In this case, the first node 110 and the second node 120 may operate according to the first mode described with reference to FIG. 2.

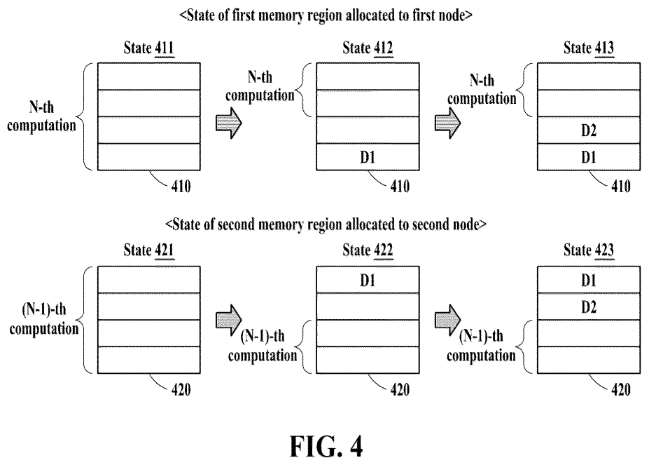

FIG. 4 is a diagram illustrating an example of a state of a memory region allocated to each of a first node and a second node of an electronic device according to an embodiment.

Referring to FIG. 4, examples of states of a first memory region 410 (which may also be referred to as a buffer) (e.g., the first memory region 114 of FIG. 2) allocated to the first node 110 and states of a second memory region 420 (which may be referred to as a buffer) (e.g., the second memory region 124 of FIG. 2) allocated to the second node 120 according to the first mode described with reference to FIG. 2 or the second mode described with reference to FIG. 3 are illustrated.

A state 411 of the first memory region 410 may include a state in which the first memory region 410 is being used for the N-th computation of the first node 110.

The first node 110 may generate the data D1 while performing the N-th computation, and store the data D1 in the first memory region 410. While the first node 110 performs the N-th computation, an empty space may be generated in the first memory region 410, and the data D1 generated while performing the N-th computation may be stored in the empty space of the first memory region 410. A state 412 of the first memory region 410 may include, for example, a state in which a portion of the first memory region 410 is being used for the N-th computation of the first node 110 and a state in which the data D1 is stored in the portion of the first memory region 410 for the transmission of the data D1.

The first node 110 may generate the data D2 while performing the N-th computation, and store the data D2 in the first memory region 410. A state 413 of the first memory region 410 may include, for example, a state in which a portion of the first memory region 410 is being used for the N-th computation of the first node 110 and a state in which the data D1 and D2 are stored in the portion of the first memory region 410 for the transmission of the data D1 and D2.

For the first node 110, a memory region (or a buffer) for the N-th computation and a memory region (or a buffer) for the data transmission may not be allocated separately. As illustrated in the example in FIG. 4, the N-th computation and the data transmission may be performed within the allocated first memory region 410.

A state 421 of the second memory region 420 may correspond to a state in which the second memory region 420 is being used for the (N-1)-th computation of the second node 120.

The second node 120 may receive the data D1 from the first node 110 while performing the (N-1)-th computation, and store the received data D1 in the second memory region 420. While the second node 120 performs the (N-1)-th computation, an empty space may occur in the second memory region 420, and the second node 120 may store the received data D1 in the empty space of the second memory region 420. A state 422 of the second memory region 420 may include a state in which a portion of the second memory region 420 is being used for the (N-1)-th computation of the second node 120 and a state in which the data D1 is received.

The second node 120 may receive the data D2 from the first node 110 while performing the (N-1)-th computation. A state 423 of the second memory region 420 may include a state in which a portion of the second memory region 420 is being used for the (N-1)-th computation of the second node 120 and a state in which the data D1 and D2 are received.

For the second node 120, a memory region for the (N-1)-th computation and a memory region for the data reception may not be allocated separately. As illustrated in the example of FIG. 4, the (N-1)-th computation and the data reception may be performed within the allocated second memory region 420.

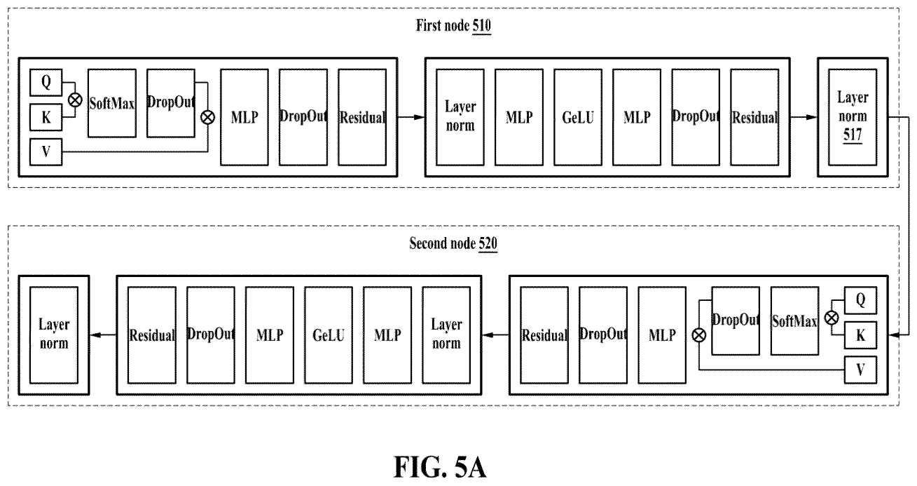

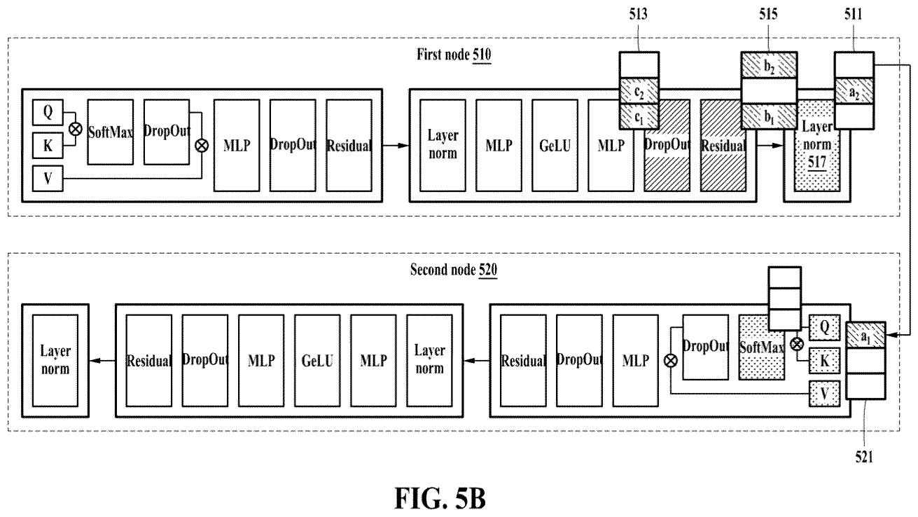

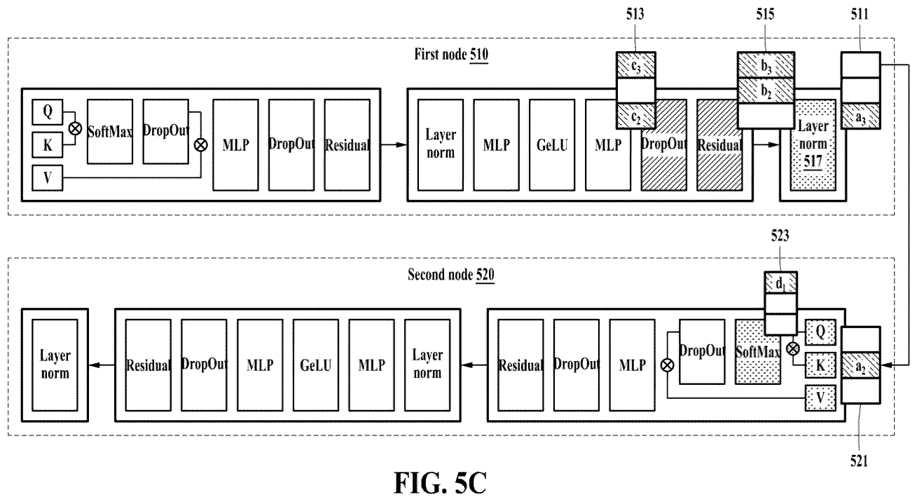

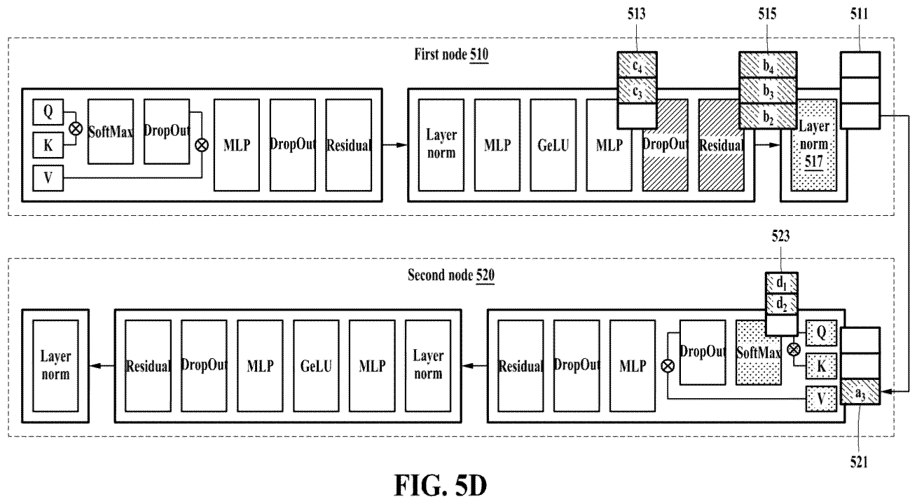

FIGS. 5A to 5D are diagrams illustrating an example of an operation of an electronic device in first model parallelism according to an embodiment. According to embodiments, a first node 510 illustrated in FIGS. 5A to 5D may correspond to the first node 110 discussed above, and a second node 520 illustrated in FIGS. 5A to 5D may correspond to the second node 120 discussed above.

According to embodiments, the first model parallelism (e.g., pipeline parallelism) may represent or refer to, for example, may refer to a parallelism in which one node of the electronic device 100 may process one or more transformer blocks and transmit the processing results to another node of the electronic device 100. The transformer block may include, for example, at least one from among a matrix multiplication between a Q matrix (e.g., the product of the multiplication between the Q weights and an input matrix) and a K matrix (e.g., the product of the multiplication between K weights and an input matrix), a softmax operation (illustrated as “SoftMax”), a multi-layer perceptron (MLP) operation (illustrated as “MLP”), a dropout operation (illustrated as “DropOut”), a layer norm computation (illustrated as “Layer norm”), a Gaussian error linear unit (GeLU) activation operation (illustrated as “GeLU”), and the like.

Referring to FIG. 5A, the first node 510 (e.g., the first node 110) of the electronic device 100 may process one or more transformer blocks. The first node 510 may generate data a₁ through a layer norm computation 517, and store the data a₁ in an output buffer (e.g., a portion of the first memory region 114) of the first node 510. The data a₁ may correspond to, for example, a row vector (or a matrix). The first node 510 may transmit the data a₁ to the second node 520 (e.g., the second node 120) while processing the one or more transformer blocks. The first node 510 may transmit the data a₁ to the second node 520 even if the output buffer is not fully filled. A bandwidth used for the transmission of the data a₁ may match, for example, an input rate of the second node 520, but embodiments are not limited thereto. For example, the first node 510 may transmit the data a₁ to the second node 520 at a bandwidth matching the input rate of the second node 520.

The second node 520 of the electronic device 100 may receive the data a₁ from the first node 510, and store the data a₁ in an input buffer (e.g., a portion of the second memory region 124) of the second node 520.

Referring to FIG. 5B, as the first node 510 transmits the data a₁ to the second node 520, an output buffer 511 of the first node 510 may not include the data a₁, and the data a₁ may be stored in an input buffer 521 (e.g., a portion of the second memory region 124) of the second node 520.

The first node 510 may generate data a₂ through the layer norm computation 517 and store the data a2 in the output buffer 511. The data a₂ may correspond to, for example, a row vector (or a matrix). A matrix 515 may correspond to an input (or input data) of a computation (e.g., the layer norm computation 517), and a matrix 513 may correspond to an input (or input data) of a computation (e.g., a dropout computation). The first node 510 may store the matrix 513 and the matrix 515 in the first memory region 114. Each of data c₁ and data c₂ of the matrix 513 may have a row vector form (or a matrix form), and each of data b₁ and data b₂ of the matrix 515 may have a row vector form (or a matrix form).

Referring to FIG. 5C, the first node 510 may transmit the data a₂ stored in the output buffer 511 to the second node 520. The second node 520 may store the received data a₂ in the input buffer 521. The second node 520 may generate a first Q matrix, a first K matrix, and a first V matrix by respectively applying a Q weight, a K weight, and a V weight to the data a₁ obtained from the input buffer 521. The second node 520 may perform the matrix multiplication on the first Q matrix and the first K matrix. A result of the matrix multiplication on the first Q matrix and the first K matrix may represent or refer to, for example, data d₁. A matrix 523 may correspond to an input (or input data) of a computation (e.g., softmax computation), and the data d₁ may be filled in a row of the matrix 523.

The first node 510 may generate data a₃ through the layer norm computation 517 and store data a₃ in the output buffer 511. The data a₃ may correspond to, for example, a row vector (or a matrix). The matrix 515 may include the data b₂ and data b₃, and the matrix 513 may include the data c₂ and data c₃.

Referring to FIG. 5D, the first node 510 may transmit the data a₃ stored in the output buffer 511 to the second node 520. The second node 520 may store the received data a₃ in the input buffer 521. The second node 520 may obtain the data a₂ from the input buffer 521, and generate a second Q matrix, a second K matrix, and a second V matrix by respectively applying a Q weight, a K weight, and a V weight to the obtained data a₂. The second node 520 may perform the matrix multiplication on the second Q matrix and the second K matrix. A result of the matrix multiplication on the second Q matrix and the second K matrix may represent or refer to, for example, data d₂. A row of the matrix 523 may be filled with the data d₂

The matrix 515 may include the data b₂, the data b₃, and data b₄, and the matrix 513 may include the data c₃ and data c₄. In the example illustrated in FIG. 5D, because the matrix 515 may be fully filled, the first node 510 may perform the layer norm computation 517 on the matrix 515 of FIG. 5D.

According to an embodiment, in the pipeline parallelism, the first node 510 may transmit the data (e.g., the data a₁, the data a₂, and the data a₃) to the second node 520 at a rate corresponding to the input rate of the second node 520. The second node 520 may receive the data from the first node 510 at a rate corresponding to the input rate of the second node 520, and may perform the computation based on data having a unit that may be used to perform the computation (e.g., one or more rows) being stored in the input buffer 521 even if the input buffer 521 is not fully filled. Accordingly, the communication and the computation of the second node 520 may be performed seamlessly (e.g., without interruption, latency, or idling). In addition, a size of the output buffer of the first node 510 and/or a size of the input buffer of the second node 520 may not be equal to a total size of activation values of an LLM and may be smaller than the total size of the activation values of the LLM.

The description provided with reference to FIGS. 1 to 4 may apply to the operations of the electronic device of FIGS. 5A to 5D.

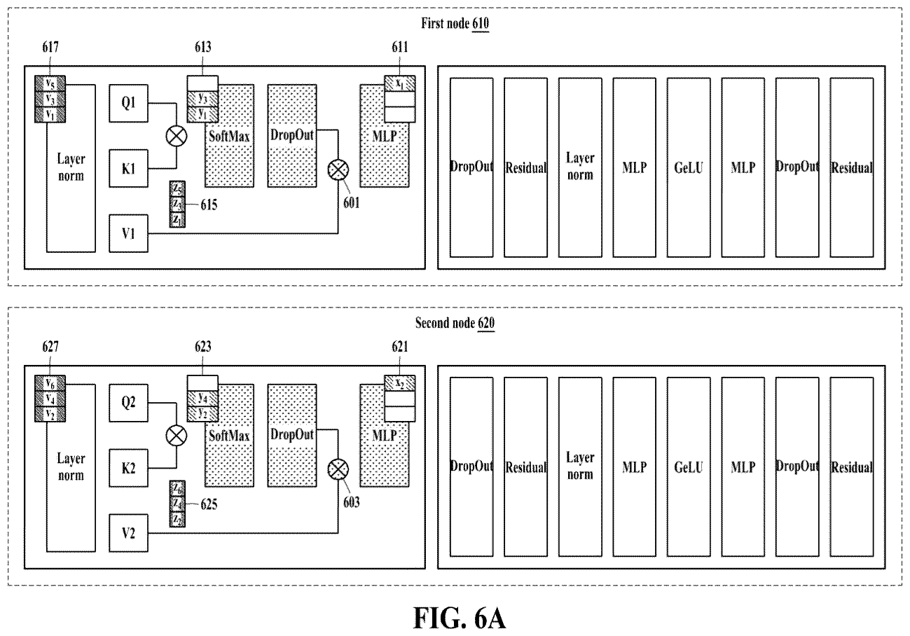

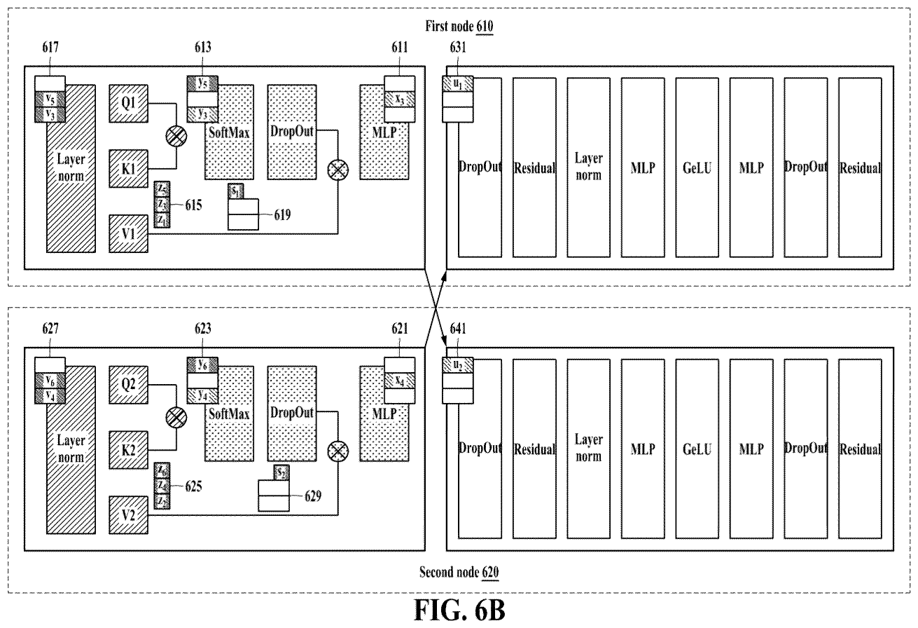

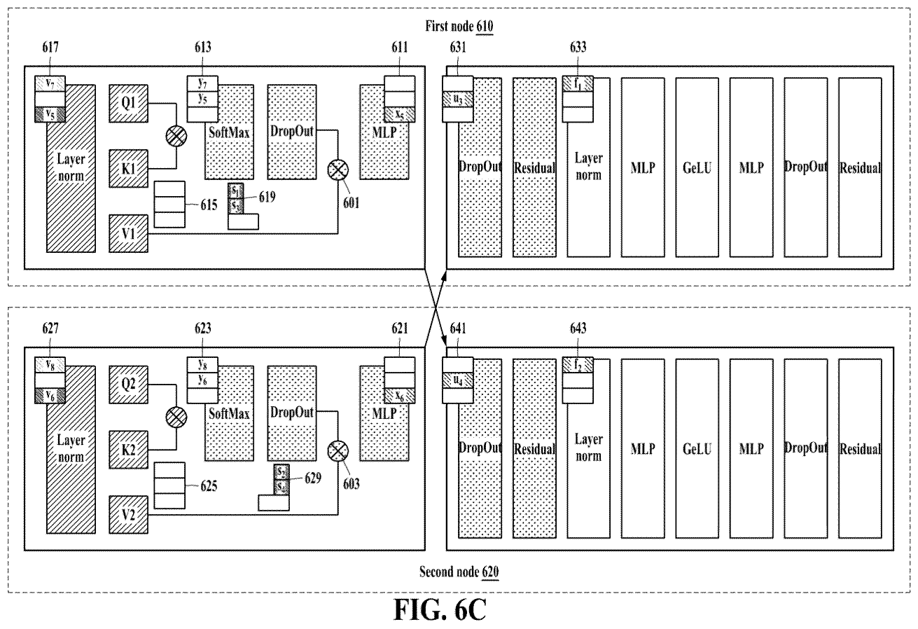

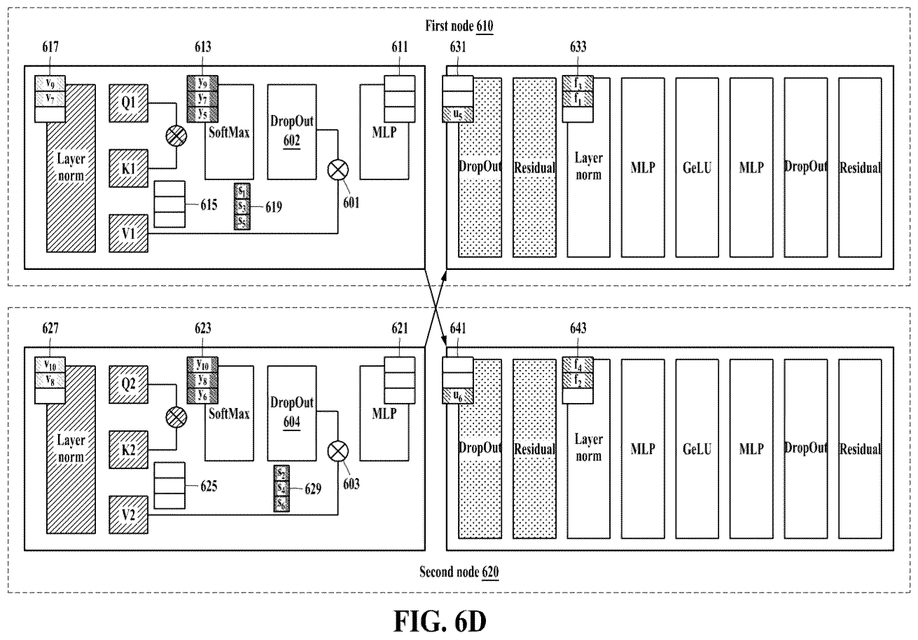

FIGS. 6A to 6D are diagrams illustrating an example of an operation of an electronic device in second model parallelism according to an embodiment. According to embodiments, a first node 610 illustrated in FIGS. 6A to 6D may correspond to the first node 110 discussed above, and a second node 620 illustrated in FIGS. 6A to 6D may correspond to the second node 120 discussed above.

According to embodiments second model parallelism (e.g., tensor parallelism) may represent or refer to, for example, may refer to a parallelism in which a weight matrix of an LLM is divided into a plurality of matrices to be processed by each node of the electronic device 100, and the processing results are summed.

Referring to FIG. 6A, an input 617 and an output 611 may be stored in the first memory region 114 of the first node 610 (e.g., the first node 110) of the electronic device 100, and an input 627 and an output 621 may be stored in the second memory region 124 of the second node 620 (e.g., the second node 120) of the electronic device 100. A size of the input 617 may be the same as a size of the input 627.

The input 617 may correspond to an input (or input data) of the layer norm computation of the first node 610, the output 611 may represent or refer to a result of the MLP computation of the first node 610, and a matrix 613 may correspond to a result of the matrix multiplication (e.g., a result of the multiplication between a Q1 matrix and a K1 matrix) (or an input of the softmax computation). Here, the Q1 matrix may represent or refer to the result of the matrix multiplication of a previous input and a Q1 weight (e.g., half of the Q weight) of the first node 610, and the K1 matrix may represent or refer to the result of the matrix multiplication of a previous input and a K1 weight (e.g., half of the K weight) of the first node 610. A matrix 615 may represent or refer to the result of the matrix multiplication of a V1 weight (e.g., half of the V weight) and the previous input, and may correspond to an input of a matrix multiplication computation 601. At least one of the output 611, the matrix 613, the matrix 615, and the input 617 may be stored in the first memory region 114 allocated to the first node 610.

The input 627 may correspond to an input (or input data) of the layer norm computation of the second node 620 of the electronic device 100, the output 621 may represent or refer to a result of the MLP computation of the second node 620, and a matrix 623 may correspond to a result of the matrix multiplication (e.g., a result of the multiplication between a Q2 matrix and a K2 matrix) (or an input of the softmax computation). Here, the Q2 matrix may represent or refer to the result of the matrix multiplication of a previous input and a Q2 weight (e.g., the other half of the Q weight) of the second node 620, and the K2 matrix may represent or refer to the result of the matrix multiplication of a previous input and a K2 weight (e.g., the other half of the K weight) of the second node 620. A matrix 625 may represent or refer to the result of the matrix multiplication of a V2 weight (e.g., the other half of the V weight) and the previous input, and may correspond to an input of a matrix multiplication computation 603. At least one or all of the output 621, the matrix 623, the matrix 625, and the input 627 may be stored in the second memory region 124 allocated to the second node 620.

Referring to FIG. 6B, the first node 610 may receive data x₂ of the output 621 from the second node 620, and the second node 620 may receive data x₁ of the output 611 from the first node 610.

The first node 610 may derive data u₁ by adding data x₁ and data x₂, and the second node 620 may derive data u₂ by adding the data x₁ and the data x₂. A value of the data u₁ may be the same as a value of the data u₂.

The first node 610 may store the data u₁ in the first memory region 114. A row of an input 631 of the computation (e.g., the dropout computation) of the first node 610 may be filled with the data u₁, which may indicate that the data u₁ is stored in the first memory region 114 (or the buffer). The second node 620 may store the data u₂ in the second memory region 124. A row of an input 641 of the computation (e.g., the dropout computation) of the second node 620 may be filled with the data u₂, which may indicate that the data u₂ is stored in the second memory region 124 (or the buffer).

The first node 610 may derive data x₃ through the MLP computation and store the data x₃ in the first memory region 114. A row of the output 611 may be filled with the data x₃. The second node 620 may derive data x₄ through the MLP computation and store the data x₄ in the second memory region 124. A row of the output 621 may be filled with the data x₄

The first node 610 may perform the layer norm computation on data v₁ of the input 617. The first node 610 may generate a (1-1)-th Q matrix and a (1-1)-th K matrix by applying each of the Q1 weight and the K1 weight to the result of the layer norm computation, and may perform the matrix multiplication on the (1-1)-th Q matrix and the (1-1)-th K matrix. Data y₅ of the matrix 613 may correspond to a result of the matrix multiplication between the (1-1)-th Q matrix and the (1-1)-th K matrix. The first node 610 may generate data s₁ by applying the V1 weight to the result of the layer norm computation and store the data s₁ in the first memory region 114. A row of a matrix 619 may be filled with the data s₁, which may indicate that the data s₁ is stored in the first memory region 114 (or the buffer).

The second node 620 may perform the layer norm computation on data v₂ of the input 627. The second node 620 may generate a (2-1)-th Q matrix and a (2-1)-th K matrix by applying each of the Q2 weight (e.g., the other half of the Q weight) and the K2 weight (e.g., the other half of the K weight) to the result of the layer norm computation, and may perform the matrix multiplication on the (2-1)-th Q matrix and the (2-1)-th K matrix. Data y₆ of the matrix 623 may correspond to a result of the matrix multiplication between the (2-1)-th Q matrix and the (2-1)-th K matrix. The second node 620 may generate data s₂ by applying the V2 weight to the result of the layer norm computation and store the data s₂ in the second memory region 124. A row of a matrix 629 may be filled with the data s₂, which may indicate that the data s₂ is stored in the second memory region 124 (or the buffer).

In the example illustrated in FIG. 6B, each of a size of data filled in one row of the matrix 615 and a size of the data s₁ of the matrix 619 of the first node 610 may be a half of the size of data filled in one row of the input 617, a half of the size of data filled in one row of the matrix 613, or a half of the size of data filled in one row of the output 611. For example, the sizes of data v₃, data y₃, and data x₃ may be the same as each other, and a size of each of data z₁ and the data s₁ may be a half of a size of each of the data v₃, the data y₃, and the data x₃.

A size of data filled in one row of the matrix 625 and a size of the data s₂ of the matrix 629 of the second node 620 may be a half of the size of data filled in one row of the input 627, a half of the size of data filled in one row of the matrix 623, or a half of the size of data filled in one row of the output 621. For example, the sizes of data v₄, data y₄, and data x₄ may be the same as each other, and a size of each of data z₂ and the data s₂ may be a half of a size of each of the data v₄, the data y₄, and the data x₄.

Referring to FIG. 6C, the first node 610 may obtain data u₁ from the first memory region 114, and perform a computation on the data u₁ to derive data f₁. The first node 610 may store the data f₁ in the first memory region 114. A row of a matrix 633 may be filled with the data f₁. The second node 620 may obtain data u₂ from the second memory region 124, and perform a computation on the data u₂ to derive data f₂. The second node 620 may store the data f₂ in the second memory region 124. A row of a matrix 643 may be filled with the data f₂.

The first node 610 may receive data x₄ of the output 621 from the second node 620, and the second node 620 may receive data x₃ of the output 611 from the first node 610.

The first node 610 may derive data u₃ by adding data x₃ and data x₄, and the second node 620 may derive data u₄ by adding the data x₃ and the data x₄. A value of the data u₃ may be the same as a value of the data u₄.

The first node 610 may store the data u₃ in the first memory region 114. A row of the input 631 of the computation (e.g., the dropout computation) of the first node 610 may be filled with the data u₃. The second node 620 may store the data u₄ in the second memory region 124. A row of the input 641 of the computation (e.g., the dropout computation) of the second node 620 may be filled with the data u₄.

The first node 610 may store the data x₅ (e.g., a result of the MLP computation) in the first memory region 114. A row of the output 611 may be filled with the data x₅. The second node 620 may store the data x₆ (e.g., a result of the MLP computation) in the second memory region 124. A row of the output 621 may be filled with the data x₆.

The first node 610 may perform the layer norm computation on data v₃ of the input 617. The first node 610 may generate a (1-2)-th Q matrix and a (1-2)-th K matrix by applying each of the Q1 weight and the K1 weight to the result of the layer norm computation, and may perform the matrix multiplication on the (1-2)-th Q matrix and the (1-2)-th K matrix. Data y₇ of the matrix 613 may correspond to a result of the matrix multiplication between the (1-2)-th Q matrix and the (1-2)-th K matrix. The first node 610 may generate data s₃ by applying the V1 weight to the result of the layer norm computation and store the data s₃ in the first memory region 114. A row of the matrix 619 may be filled with the data s₃. In the example illustrated in FIG. 6C, the matrix 615 is shown as being not filled, which may indicate that the matrix 615 is used in the matrix multiplication computation 601.

The second node 620 may perform the layer norm computation on the data v₄ of the input 627. The second node 620 may generate a (2-2)-th Q matrix and a (2-2)-th K matrix by applying each of the Q2 weight and the K2 weight to the result of the layer norm computation, and may perform the matrix multiplication on the (2-2)-th Q matrix and the (2-2)-th K matrix. Data y₈ of the matrix 623 may correspond to a result of the matrix multiplication between the (2-2)-th Q matrix and the (2-2)-th K matrix. The second node 620 may generate data s₄ by applying the V2 weight to the result of the layer norm computation and store the data s₄ in the second memory region 124. A row of the matrix 629 may be filled with the data s₄. In the example illustrated in FIG. 6C, the matrix 625 is shown as being not filled, which may indicate that the matrix 625 is used in the matrix multiplication computation 603.

In the example illustrated in FIG. 6C, the size of the data s₃ of the matrix 619 of the first node 610 may be the same as the size of the data s₁ of the matrix 619. The size of the data s₄ of the matrix 629 of the second node 620 may be the same as the size of the data s₂ of the matrix 629.

Referring to FIG. 6D, the first node 610 may obtain data u₃ from the first memory region 114, and perform a computation on the data u₃ to derive data f₃. The first node 610 may store the data f₃ in the first memory region 114. A row of the matrix 633 may be filled with the data f₃. The second node 620 may obtain data u₄ from the second memory region 124, and perform a computation on the data u₄ to derive data f₄. The second node 620 may store the data f₄ in the second memory region 124. A row of the matrix 643 may be filled with the data f₄.

The first node 610 may receive data x₆ of the output 621 from the second node 620, and the second node 620 may receive data x₅ of the output 611 from the first node 610.

The first node 610 may derive data u₅ by adding data x₅ and data x₆, and the second node 620 may derive data u₆ by adding the data x₅ and the data x₆. A value of the data u₅ may be the same as a value of the data u₆.

The first node 610 may store the data u₅ in the first memory region 114. A row of the input 631 of the computation (e.g., the dropout computation) of the first node 610 may be filled with the data u₅. The second node 620 may store the data u₆ in the second memory region 124. A row of the input 641 of the computation (e.g., the dropout computation) of the second node 620 may be filled with the data u₆.

The first node 610 may perform the layer norm computation on data v₅ of the input 617. The first node 610 may generate a (1-3)-th Q matrix and a (1-3)-th K matrix by applying each of the Q1 weight and the K1 weight to the result of the layer norm computation, and may perform the matrix multiplication on the (1-3)-th Q matrix and the (1-3)-th K matrix. Data y₉ of the matrix 613 may correspond to a result of the matrix multiplication between the (1-3)-th Q matrix and the (1-3)-th K matrix. The first node 610 may generate data s₅ by applying the V1 weight to the result of the layer norm computation and store the data s₅ in the first memory region 114. A row of the matrix 619 may be filled with the data s₅. When the time to perform the matrix multiplication computation on a result of a dropout computation 602 and the matrix 619 arrives, the first node 610 may perform the matrix multiplication computation 601 on the result of the dropout computation 602 and the matrix 619.

The second node 620 may perform the layer norm computation on the data v₆ of the input 627. The second node 620 may generate a (2-3)-th Q matrix and a (2-3)-th K matrix by applying each of the Q2 weight and the K2 weight to the result of the layer norm computation, and may perform the matrix multiplication on the (2-3)-th Q matrix and the (2-3)-th K matrix. Data y₁₀ of the matrix 623 may correspond to a result of the matrix multiplication between the (2-3)-th Q matrix and the (2-3)-th K matrix. The second node 620 may generate data s₆ by applying the V2 weight to the result of the layer norm computation and store the data s₆ in the second memory region 124. A row of the matrix 629 may be filled with the data s₆. When the time to perform the matrix multiplication computation on a result of a dropout computation 604 and the matrix 629 arrives, the second node 620 may perform the matrix multiplication computation 603 on the result of the dropout computation 604 and the matrix 629.

In the example illustrated in FIG. 6D, the size of the data s₅ of the matrix 619 of the first node 610 may be the same as the size of each of the data s₁ and the data s₃. The size of the data s₆ of the matrix 629 of the second node 620 may be the same as the size of each of the data s₂ and the data s₄.

According to an embodiment, the first node 610 may transmit each of the data x₁, the data x₃, and the data x₅ to the second node 620 each time the data is ready in the output 611, even if the output 611 is not fully filled. At the same time, the first node 610 may perform the computation. Also, the second node 620 may transmit each of the data x₂, the data x₄, and the data x₆ to the first node 610 each time the data is ready in the output 621, even if the output 621 is not fully filled. At the same time, the second node 620 may perform the computation. The second node 620 may receive data from the first node 610 at a rate corresponding to the input rate of the second node 620, and thus, the communication and computation of the second node 620 may be performed seamlessly.

The description provided with reference to FIGS. 1 to 4 may apply to the operations of the electronic device of FIG. 6.

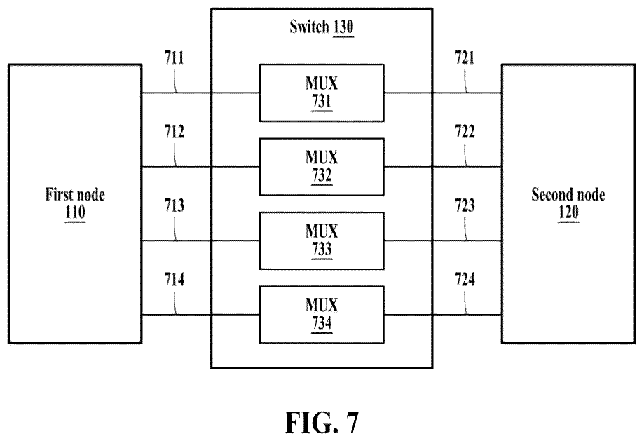

FIGS. 7 to 9 are diagrams illustrating a switch of an electronic device according to an embodiment.

Referring to FIG. 7, the switch 130 of the electronic device 100 according to an embodiment may include a plurality of multiplexers (MUX) (e.g., a MUX 731, a MUX 732, a MUX 733, and a MUX 734).

The switch 130 may be connected to the first node 110 by a plurality of first channels (e.g., a first channel 711, a first channel 712, a first channel 713, and a first channel 714). The switch 130 may be connected to the second node 120 by a plurality of second channels (e.g., a second channel 721, a second channel 722, a second channel 723, and a second channel 724). The MUX 731 may be connected to the first channel 711 and the second channel 721. The MUX 732 may be connected to the first channel 712 and the second channel 722. The MUX 733 may be connected to the first channel 713 and the second channel 723. The MUX 734 may be connected to the first channel 714 and the second channel 724.

The first node 110 and the second node 120 may operate according to the first mode or the second mode. The first node 110 may transmit data to the second node 120 using the switch 130 in the first mode or the second mode. For example, according to the first mode, when the readiness information (e.g., the grant 210 of FIG. 2) indicating the state of being ready to receive data is received from the second node 120, the first node 110 may transmit the data to the second node 120 using the switch 130. According to the second mode, the first node 110 may perform the time synchronization with the second node 120. After the time synchronization is performed, the first node 110 may transmit the data to the second node 120 using the switch 130.

According to an embodiment, the operations of the first node 110 and the second node 120 may be based on pipeline parallelism or tensor parallelism.

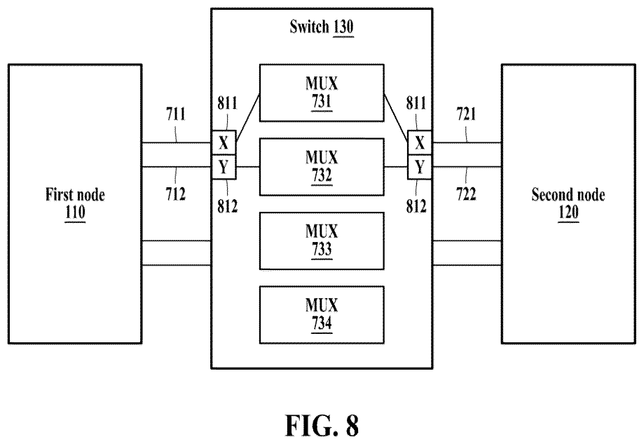

According to an embodiment, the number of channels used by the first node 110 to transmit data to the switch 130 among the first channels 711, 712, 713, and 714 may be determined based on a bandwidth scaling value. For example, a host processor may determine a bandwidth scaling value based on the amount of computation and communication associated with the nodes within the electronic device 100. In the example shown in FIG. 8, the bandwidth scaling value may be determined to be one half (“½”). The first node 110 may have a bandwidth scaling value of one half (“½”), and thus may transmit data X 811 and data Y 812 to the switch 130 using half of the first channels 711, 712, 713, and 714, as in the example illustrated in FIG. 8 (e.g., using the first channels 711 and 712 of FIG. 8).

The first node 110 may transmit the data X 811 to the switch 130 using the first channel 711 and transmit the data Y 812 to the switch 130 using the first channel 712. Based on the data X 811 being received, the switch 130 may control the MUX 731 connected to the first channel 711. By such a control, the MUX 731 may transmit the data X 811 to the second channel 721 of the second node 120. The second node 120 may receive the data X 811 from the switch 130 using the second channel 721. Based on the data Y 812 being received, the switch 130 may control the MUX 732 connected to the first channel 712. By such a control, the MUX 732 may transmit the data Y 812 to the second channel 722 of the second node 120. The second node 120 may receive the data Y 812 from the switch 130 using the second channel 722.

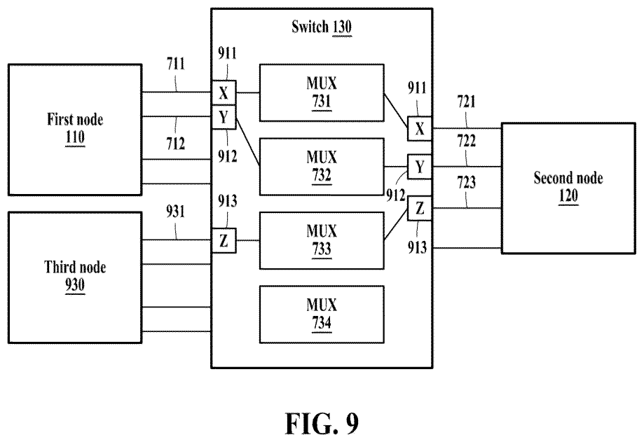

According to an embodiment, the electronic device 100 may transmit data of at least one node to another node without latency through the switch 130. For example, in the example illustrated in FIG. 9, the switch 130 may be connected to a third node 930 using a plurality of third channels. The third node 930 may use a third channel 931 among the plurality of third channels according to a bandwidth scaling value (e.g., one quarter (“¼”)), and transmit data Z 913 to the switch 130 using the third channel 931. The switch 130 may transmit data X 911, data Y 912, and the data Z 913 to the second node 120 using the second channels 721, 722, and 723. Accordingly, the electronic device 100 may transmit the data X 911, the data Y 912, and the data Z 913 to the second node 120 without latency.

The switch of the electronic device 101 of FIG. 1A may receive data from a node A (e.g., the node A of FIG. 1A) at a maximum bandwidth and transmit data to a node B (e.g., the node B of FIG. 1A) at the maximum bandwidth. Because the switch of the electronic device 101 may communicate with each of the node A and the node B at the maximum bandwidth, congestion may occur in the switch of the electronic device 101, and such congestion may not allow the switch of the electronic device 101 to receive data from the third node 930. This may cause the node B of the electronic device 101 to take a relatively long time to receive data from the third node 930. As a result, significant latency may occur. In contrast, according to an embodiment, because each of the first node 110 and the third node 930 may divide the bandwidth according to the bandwidth scaling value as described above with reference to FIGS. 8 and 9, the congestion may not occur, and at least two of the data reception, the computation, and the data transmission may be performed simultaneously.

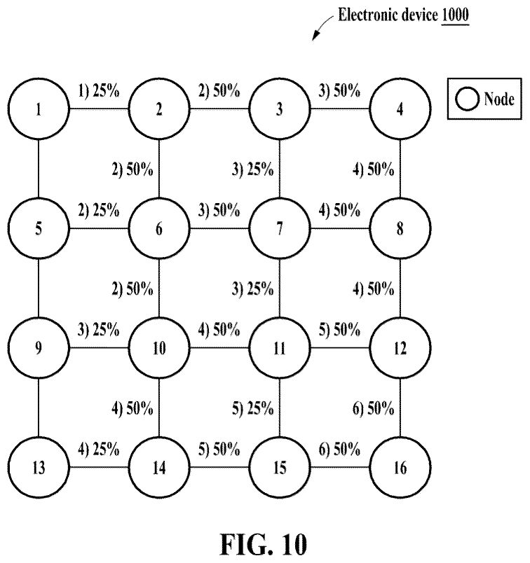

FIG. 10 is a diagram illustrating an example of an operation of an electronic device according to an embodiment.

Referring to FIG. 10, an electronic device 1000 according to an embodiment may include a plurality of nodes (e.g., a node 1, a node 2, a node 3, a node 4, a node 5, a node 6, a node 7, a node 8, a node 9, a node 10, a node 11, a node 12, a node 13, a node 14, a node 15, and a node 16, as illustrated in FIG. 10). The electronic device 1000 of FIG. 10 may be an example of, or may otherwise correspond to, the electronic device 100.

According to an embodiment, the electronic device 1000 may have or may include (e.g., may be arranged according to) a Network on Chip (NoC) structure (or a multi-core structure). In this case, each node of the electronic device 1000 may correspond to at least one core. However, embodiments are not limited thereto, and in some embodiments the electronic device 1000 may have a different structure, for example a Network on Package (NoP) structure (or a multi-chip structure) using a chiplet. In this case, each node of the electronic device 1000 may correspond to one chip.

A host processor may perform scheduling by considering the performance and resources of each node within the electronic device 1000, and determine a bandwidth scaling value between nodes (e.g., connected nodes) based on the amount of computation and/or communication of each node within the electronic device 1000. In FIG. 10, a value with % may represent or refer to a bandwidth scaling value between connected nodes. For example, the bandwidth scaling value between the node 1 and the node 2 may be determined as 25% (or one quarter (“¼”)), the bandwidth scaling value between the node 2 and the node 3 may be determined as 50% (or one half (“½”)), and the bandwidth scaling value between the node 2 and the node 6 may be determined as 50% (or one half (“½”)). The bandwidth scaling value between the node 3 and the node 4 may be determined as 50% (or one half (“½”)), and the bandwidth scaling value between the node 3 and the node 7 may be determined as 25% (or one quarter (“¼”)).

The operations of nodes within the electronic device 1000 may be optimized through the scheduling and the bandwidth scaling values described above.

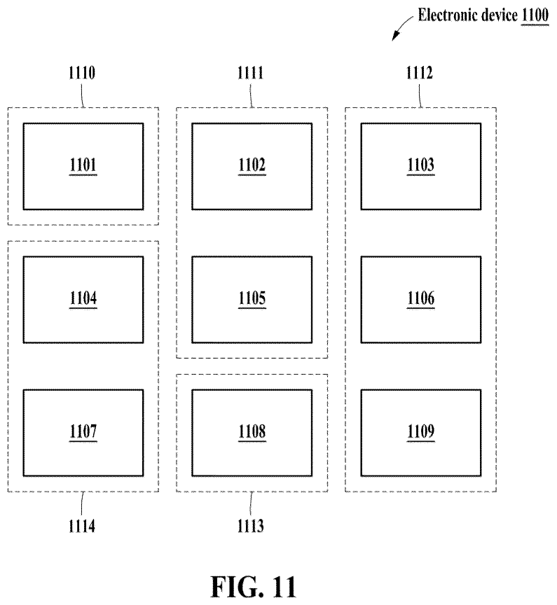

FIG. 11 is a diagram illustrating an example of an operation of an electronic device according to an embodiment.

Referring to FIG. 11, the electronic device 1100 according to an embodiment may include a plurality of cores. The electronic device 1100 of FIG. 11 may be an example of, or may otherwise correspond to, the electronic device 100.

In the example illustrated in FIG. 11, a core 1101 may be allocated for processing of a first fused layer 1110 of an LLM, a core 1102 and a core 1105 may be allocated for processing of a second fused layer 1111 of the LLM, a core 1103, a core 1106, and a core 1109 may be allocated for processing of a third fused layer 1112 of the LLM, a core 1108 may be allocated for processing of a fourth fused layer 1113, and a core 1104 and a core 1107 may be allocated for processing of a fifth fused layer 1114.

A single fused layer may correspond to, for example, a fused layer of successive layers of an LLM. In the example illustrated in FIG. 11, a next layer of the first fused layer 1110 may be the second fused layer 1111, a next layer of the second fused layer 1111 may be the third fused layer 1112, a next layer of the third fused layer 1112 may be the fourth fused layer 1113, and a next layer of the fourth fused layer 1113 may be the fifth fused layer 1114.

One core (e.g., the core 1101) may be allocated to the first fused layer 1110, and two cores (e.g., the core 1102 and the core 1105) may be allocated to the second fused layer 1111. When a relatively large number of cores are allocated to the second fused layer 1111 than to the first fused layer 1110, starvation (e.g., lack of data) may occur in the second fused layer 1111, even if data is transmitted from the first fused layer 1110 to the second fused layer 1111 at the maximum bandwidth.

According to an embodiment, a host processor may allocate one or more cores to each fused layer based on an output rate of each fused layer, a bandwidth (e.g., an interconnection bandwidth between successive fused layers), and an input rate of each fused layer. At this time, the host processor may allocate one or more cores to each fused layer such that the output rate and input rate each do not exceed the maximum bandwidth (e.g., a maximum interconnection bandwidth). According to the implementation, one or more cores may be allocated to each fused layer so that the output rate of a fused layer and the input rate of a next fused layer may be the same, but embodiments are not limited thereto.

For example, the host processor may allocate one or more cores to the first fused layer 1110 such that the output rate of the first fused layer 1110 is less than or equal to the maximum interconnection bandwidth. The host processor may allocate one or more cores to the second fused layer 1111 so that the second fused layer 1111 may process data at the output rate of the first fused layer 1110. The host processor may allocate one or more cores to the second fused layer 1111 so that the input rate of the second fused layer 1111 may match the output rate of the first fused layer 1110. Because the cores may be allocated for the processing of the fused layers (e.g., because job partitioning may be performed) as described above, the starvation described above may be prevented or reduced.

Descriptions of the operation between the first node and the second node described above may be applied to the operation between the fused layer and the next fused layer of FIG. 11.

The description provided with reference to FIGS. 1 to 10 may apply to the electronic device 1100 of FIG. 11.

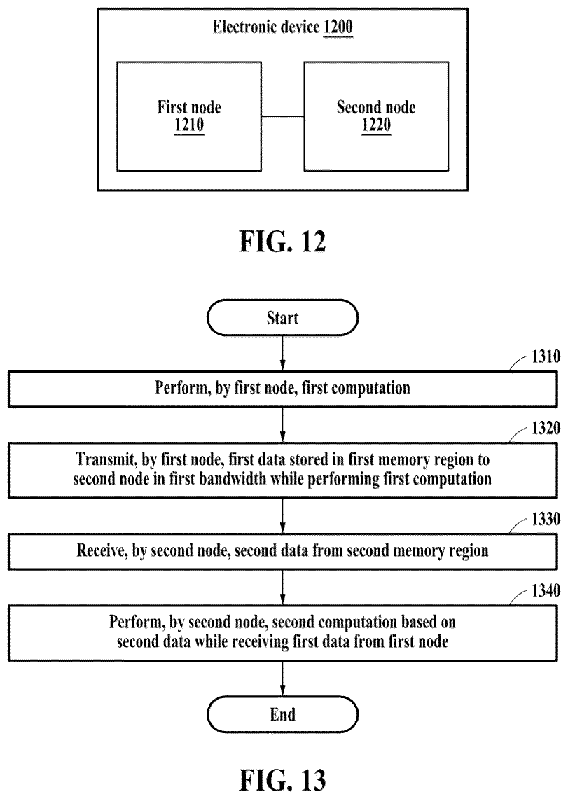

FIG. 12 is a block diagram illustrating an example of a configuration of an electronic device according to an embodiment.

Referring to FIG. 12, an electronic device 1200 (e.g., at least one of the electronic device 100, the electronic device 1000, and the electronic device 1100) according to an embodiment may include a first node 1210 (e.g., at least one of the first node 110, the first node 510, and the first node 610) and a second node 1220 (e.g., at least one of the second node 120, the second node 520, and the second node 620).

Each of the first node 1210 and the second node 1220 may include a first memory (e.g., SRAM) and a second memory (e.g., HBM). Each of the first node 1210 and the second node 1220 may represent or refer to a computing node.

The first node 1210 may perform the first computation. The first node 1210 may transmit first data stored in first memory region allocated to the first node 1210 at a first bandwidth to the second node 1220 while performing the first computation. The allocated first memory region may include a space used for the first computation of the first node 1210 and a space storing (e.g., configured to store) the first data for the transmission of the first data.

The second node 1220 may receive the first data from the first node 1210, and receive second data from a second memory region allocated to the second node 1220. The second node 1220 may perform a second computation based on the second data while receiving the first data. The allocated second memory region may include a space for receiving the first data, a space for storing (e.g., configured to store) the second data, and a space used for the second computation.

The first bandwidth of the first node 1210 may be related to (e.g., may correspond to, or may be determined based on) an input rate of the second node 1220 (e.g., a rate at which the second node 1220 receives the second data from the second memory region). For example, the first bandwidth of the first node 1210 may match the input rate of the second node 1220.

According to an embodiment, the first node 1210 may receive third data from a first other node while performing the first computation and transmitting the first data, and store the received third data in the allocated first memory region. The first node 1210 may simultaneously perform the transmission of the first data, the first computation, and the reception of the third data.

According to an embodiment, the second node 1220 may transmit fourth data stored in the allocated second memory region to a second other node while performing the second computation and receiving the first data. The second node 1220 may simultaneously perform the reception of the first data, the second computation, and the transmission of the fourth data.

According to an embodiment, the first node 1210 and the second node 1220 may operate according to the first mode in which the transmission is performed based on readiness state, which may represent or refer to a state of being ready for receiving or reception (e.g., a state of being ready to receive). According to the first mode, the second node 1220 may transmit readiness information indicating a state of being ready to receive (e.g., the grant 210 of FIG. 2) to the first node 1210. The first node 1210 may transmit the first data to the second node 1220 when the information indicating a state of being ready to receive is received from the second node 1220.

According to an embodiment, the first node 1210 and the second node 1220 may operate according to a second mode in which the communication is performed by synchronizing the time of the first node 1210 with the time of the second node 1220. According to the second mode, the first node 1210 may transmit a first synchronization signal to the second node 1220 to synchronize the time of the first node 1210 with the time of the second node 1220, and/or the second node 1220 may transmit a second synchronization signal to the first node 1210 to synchronize the time of the first node 1210 with the time of the second node 1220.

According to an embodiment, the first node 1210 and the second node 1220 may operate according to the second mode based on a time difference between the time of the first node 1210 and the time of the second node 1220 being less than or equal to a threshold value. The first node 1210 and the second node 1220 may operate according to the first mode based on a time difference between the time of the first node 1210 and the time of the second node 1220 exceeding (e.g., being greater than) a threshold value. While the first node 1210 and the second node 1220 operate according to the second mode, the time difference between the time of the first node 1210 and the time of the second node 1220 may exceed the threshold value. In this case, the first node 1210 and the second node 1220 may operate according to the first mode.

According to an embodiment, the first bandwidth of the first node 1210 may correspond to a result of applying a bandwidth scaling value to a maximum bandwidth (e.g., the maximum bandwidth of the first node 1210). Here, the bandwidth scaling value may correspond to a ratio of the first bandwidth to the maximum bandwidth. For example, based on the bandwidth scaling value being one half (“½”) (or 0.5), the first bandwidth may correspond to a result of (e.g., may be determined by) applying the bandwidth scaling value to the maximum bandwidth (e.g., a half of the maximum bandwidth).

According to an embodiment, the electronic device 1200 may further include a switch (e.g., the switch 130). The switch may receive the first data from the first node 1210 using at least one channel from among a plurality of first channels (e.g., the first channels 711, 712, 713, and 714) connected to the first node 1210. The switch may transmit the first data to the second node 1220 using at least one channel from among a plurality of second channels (e.g., the second channels 721, 722, 723, and 724) connected to the second node 1220. Among the first channels, the number of channels used by the first node 1210 to transmit the first data to the switch may be determined based on the bandwidth scaling value. For example, a total number of first channels may be four (“4”) and the bandwidth scaling value may be one half (“½”) (or 0.5). In this case, among the first channels, the number of channels used by the first node 1210 to transmit the first data to the switch may be half of the total number of first channels (e.g., two (“2”)).

According to an embodiment, the operations of the first node 1210 and the second node 1220 may be performed based on pipeline parallelism or tensor parallelism.

According to an example, the electronic device 1200 may have or may include (e.g., may be arranged according to) an NoC structure. According to the NoC structure, each of the first node 1210 and the second node 1220 may correspond to one or more cores (or processing cores). One or more cores corresponding to the first node 1210 may perform computation and communication (e.g., transmission and/or reception) simultaneously, and one or more cores corresponding to the second node 1220 may perform computation and communication (e.g., transmission and/or reception) simultaneously.

According to an embodiment, the electronic device 1200 may have or may include (e.g., may be arranged according to) a multi-chip structure. According to the multi-chip structure, each of the first node 1210 and the second node 1220 may correspond to a chip. A chip corresponding to the first node 1210 may perform computation and communication (e.g., transmission and/or reception) simultaneously, and a chip corresponding to the second node 1220 may perform computation and communication (e.g., transmission and/or reception) simultaneously.

According to an embodiment, the job partitioning for the plurality of nodes within the electronic device 1200 may be performed based on at least one from among the output rate, the bandwidth, and the input rate of each of the nodes within the electronic device 1200. For example, the host processor may perform the job partitioning for the plurality of nodes within the electronic device 1200 based on the output rate, the bandwidth, and the input rate of each of the nodes within the electronic device 1200. By such job partitioning, a first layer (e.g., the first fused layer 1110) may be allocated to the first node 1210, and a second layer (e.g., the second fused layer 1111) may be allocated to the second node. By the job partitioning, the first bandwidth of the first node 1210, the output rate of the first node, and the input rate of the second node may match each other.

The description provided with reference to FIGS. 1 to 11 may apply to the electronic device 1200 of FIG. 12.

FIG. 13 is a flowchart illustrating an operating method of an electronic device according to an embodiment.

Referring to FIG. 13, at operation 1310, the first node 1210 of the electronic device 1200 may perform a first computation.

At operation 1320, the first node 1210 may transmit first data stored in a first memory region allocated to the first node 1210 at a first bandwidth to the second node 1220 of the electronic device 1200 while performing the first computation.

At operation 1330, the second node 1220 may receive (or obtain) second data from a second memory region allocated to the second node 1220.

At operation 1340, the second node 1220 may perform the second computation based on the second data while receiving the first data from the first node.

The description provided with reference to FIGS. 1 to 12 may apply to the operating method of the electronic device 1200 of FIG. 13.

The example embodiments described herein may be implemented using a hardware component, a software component and/or a combination thereof. A processing device may be implemented using one or more general-purpose or special-purpose computers, such as, for example, a processor, a controller, an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and generate data in response to (or based on) execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc-read only memory (CD-ROM) discs, digital versatile discs (DVDs), and/or Blu-ray discs; magneto-optical media such as optical discs; and hardware devices that are specially configured to store and perform program instructions, such as read-only memory (ROM), random access memory (RAM), flash memory (e.g., universal serial bus (USB) flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

Although some embodiments are described above with reference to the limited drawings, a person having ordinary skill in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents, without departing from the scope of the disclosure.

Therefore, other implementations, other embodiments, and equivalents of the claims are within the scope of the following claims.

What is claimed is:

1. An electronic device comprising:
a first node configured to perform a first computation, and to transmit first data stored in an first memory region allocated to the first node at a first bandwidth while performing the first computation; and
a second node configured to receive the first data from the first node, receive second data from a second memory region allocated to the second node at an input rate, and perform a second computation based on the received second data while receiving the first data,
wherein the first bandwidth corresponds to the input rate.

2. The electronic device of claim 1,
wherein the first memory region comprises a space used for the first computation and a space used for transmission of the first data, and
wherein the second memory region comprises a space used for reception of the first data, a space configured to store the second data, and a space used for the second computation.

3. The electronic device of claim 1, wherein the first node is configured to receive third data from a first other node while performing the first computation and transmitting the first data, and to store the received third data in the first memory region, and
wherein the second node is configured to transmit fourth data stored in the second memory region to a second other node while performing the second computation and receiving the first data.

4. The electronic device of claim 1, wherein the first node and the second node are configured to operate according to a first mode in which the second node is configured to transmit readiness information indicating that the second node is ready for reception to the first node, and the first node is configured to transmit the first data to the second node based on the readiness information being received from the second node.

5. The electronic device of claim 1, wherein the first node and the second node are configured to operate according to a second mode in which communication is performed by synchronizing a time of the first node with a time of the second node, and
wherein, according to the second mode, at least one of the first node and the second node is configured to transmit a synchronization signal in order to synchronize the time of the first node with the time of the second node.

6. The electronic device of claim 1, wherein based on a time difference between a time of the first node and a time of the second node being less than or equal to a threshold value, the first node and the second node are configured to operate according to a second mode in which communication is performed by synchronizing the time of the first node with the time of the second node, and
wherein based on the time difference being greater than the threshold value, the first node and the second node are configured to operate according to a first mode in which transmission is performed based on a readiness state.

7. The electronic device of claim 1, wherein the first bandwidth is determined by applying a bandwidth scaling value to a maximum bandwidth, and
wherein the bandwidth scaling value corresponds to a ratio of the first bandwidth to the maximum bandwidth.

8. The electronic device of claim 1, further comprising:
a switch configured to receive the first data from the first node using at least one first channel from among a plurality of first channels connected to the first node, and to transmit the first data to the second node using at least second channel from among a plurality of second channels connected to the second node.

9. The electronic device of claim 8, wherein a number of the at least one first channel is determined based on a bandwidth scaling value.

10. The electronic device of claim 1, wherein the first node and the second node are further configured to operate based on at least one of pipeline parallelism and tensor parallelism.

11. The electronic device of claim 1, wherein the electronic device comprises a network-on-chip (NoC) structure, and
wherein each node from among the first node and the second node corresponds to one or more processing cores included in the NoC structure.

12. The electronic device of claim 1, wherein the electronic device comprises a multi-chip structure, and
wherein each node from among the first node and the second node corresponds to a chip included in the multi-chip structure.

13. The electronic device of claim 1, wherein job partitioning for a plurality of nodes in the electronic device is performed based on at least one of an output rate of each of the plurality of nodes, a bandwidth of each of the plurality of nodes, and an input rate of each of the plurality of nodes, and
wherein a first layer is allocated to the first node and a second layer is allocated to the second node as the job partitioning is performed.

14. The electronic device of claim 13, wherein the first bandwidth, the output rate of the first node, and the input rate of the second node are determined to match each other.

15. A method of operating an electronic device, the method comprising:
performing, by a first node included in the electronic device, a first computation;
transmitting, by the first node, first data stored in a first memory region allocated to the first node at a first bandwidth to a second node included in the electronic device while the first computation is performed;
receiving, by the second node, second data from a second memory region allocated to the second node at an input rate; and
performing, by the second node, a second computation based on the received second data while the first data is received from the first node,
wherein the first bandwidth corresponds to the input rate.

16. The method of claim 15, wherein the first memory region comprises a space used for the first computation and a space used for the transmitting of the first data, and
wherein the second memory region comprises a space used for the receiving of the first data, a space configured to store the second data, and a space used for the second computation.

17. The method of claim 15, further comprising:
receiving, by the first node, third data from a first other node while the first computation is performed and the first data is transmitted;
storing the received third data in the first memory region; and
transmitting, by the second node, fourth data stored in the second memory region to a second other node while the second computation is performed and the first data is received.

18. The method of claim 15, wherein the first node and the second node are configured to operate according to a first mode in which transmission is performed based on a readiness state, and
wherein the method further comprises:
transmitting, by the second node operating according to the first mode, readiness information indicating that the second node is ready for reception to the first node; and
transmitting, by the first node, the first data to the second node based on the readiness information being received from the second node.

19. The method of claim 15, wherein the first node and the second node are configured to operate according to a second mode in which communication is performed by synchronizing a time of the first node with a time of the second node, and
wherein the method further comprises:
transmitting, by the first node operating according to the second mode, a first synchronization signal to the second node in order to synchronize the time of the first node with the time of the second node; and
transmitting, by the second node, a second synchronization signal to the first node in order to synchronize the time of the first node with the time of the second node.

20. The method of claim 15, wherein the first bandwidth is determined by applying a bandwidth scaling value to a maximum bandwidth, and
wherein the bandwidth scaling value corresponds to a ratio of the first bandwidth to the maximum bandwidth.
